(19) United States
(12) Patent Application Publication
(10) Pub. No.: US 2008/0238166 A1
(43) Pub. Date: Oct. 2, 2008

(54) Vehicle or aircraft seat device

(75) Inventors: Andreas Speh, Ummendorf (DE); Jurgen Baumann, Ludwigshafen (DE)

Correspondence Address: POSZ LAW GROUP, PLC, 12040 SOUTH LAKES DRIVE, SUITE 101, RESTON, VA, 20191, US

(73) Assignee: RECARO Aircraft Seating GmbH & Co. KG, Schwabisch Hall (DE)

(21) Appl. No.: 12/073,821

(22) Filed: Mar. 11, 2008

(30) Foreign Application Priority Data
Mar. 27, 2007 (DE) 10 2007 014 524.3

(51) Int. Cl. B60N 2/02

(52) U.S. Cl. 297/311

(57) ABSTRACT

A vehicle seat device or aircraft seat device includes a seat base bearing apparatus (10), which is provided for movably supporting a seat base (12). The seat base bearing apparatus (10) has at least a first bearing unit (14), which includes at least one lever transmission (16), and at least a second bearing unit (18), which includes at least one connecting link (20).

### CROSS REFERENCE TO RELATED APPLICATION

This application is based on and incorporates by reference German Patent Application No. 10 2007 014 524.3, which was filed on 27 Mar. 2007.

### BACKGROUND OF THE INVENTION

The present invention relates to vehicle or aircraft seating, and more particularly, to a vehicle or aircraft seat device with a seat base bearing for movably supporting a seat base.

Bearing seat devices for vehicle or aircraft seats are known. For example, EP 1 116 654 B1 discloses a seat device having a seat base bearing apparatus which is provided for movably supporting the base of a seat.

### SUMMARY OF THE INVENTION

The invention is based on a seat device, in particular a vehicle seat device or aircraft seat device, having a seat base bearing apparatus which is provided for movably supporting a seat base. “Movably supporting” the base of a seat is understood in particular to mean here that when the seat base bearing apparatus moves, the base of the seat executes at least one movement relative to at least one bearing unit of the seat base bearing apparatus. In addition, “provided” is to be understood here in particular as meaning specifically equipped and/or configured.

It is proposed that the seat base bearing apparatus has at least a first bearing unit with at least one lever transmission, and at least a second bearing unit with at least one connecting link. Through corresponding configurations it is possible to achieve savings in terms of weight, components, costs and/or complexity of assembly of the seat device by virtue of the fact that the seat base bearing apparatus permits both forward movement of the base of the seat and inclination of the base of the seat. As a result, the forward movement of the base of the seat and the adjustment of the seat angle are combined in one assembly in a way which provides savings in costs and installation space. A large amount of travel of the base of the seat and in addition adjustment of the inclination of the seat surface are possible.

It is proposed that the first bearing unit which has the lever transmission be arranged in a front region of the seat device, and the second bearing unit which has the connecting link be arranged in a rear region of the seat device. As a result, the front part of the seat is moved forward by means of the lever transmission, in which case the lever transmission additionally adjusts the seat angle, i.e., the inclination of the base of the seat. The rear part of the seat is moved forward by means of the connecting link.

The seat device can be embodied in a particularly economical fashion if the lever transmission has at least one lever which is longitudinally adjustable.

A particularly fluid movement of the base of the seat can advantageously be achieved if the lever transmission has at least two levers which are connected to one another in an articulated fashion since the base of the seat therefore executes a combined movement, specifically a translatory movement and a rotational movement.

The levers can preferably be of different lengths and/or of the same length, as a result of which different settings of the adjustment travel of the base of the seat can be made.

In addition it is proposed that the connecting link has a linear and/or a curved profile. As a result, the profile of the connecting link can allow for a wide variety of conditions in terms of the installation space, the assembly, the user friendliness etc.

The connecting link advantageously has a U-shaped cross section, which permits cost-effective and simple manufacture of the component. Furthermore, the simple geometry permits secure guidance of a guiding element of the second bearing unit.

In a further embodiment of the invention, an actuation device is provided which serves to drive the seat base bearing apparatus. This permits simple and comfortable adjustment of the seat device.

The actuation device is preferably provided on the lever transmission. In particular, the actuation device is operatively connected to at least one lever in such a way that the actuation device is hardly loaded in a starting position, landing position and rolling position (TTL position) of the seat device since crash loads which may possibly occur during starting, landing and rolling of the aircraft are applied essentially directly into the seat device by the lever transmission.

The actuation device advantageously additionally serves to dampen the actuation movement of the seat device, as a result of which a separate component for damping can be eliminated.

Owing to the possible reduction in weight, the seat device according to the invention is suitable in particular for an aircraft seat. However, basically a corresponding seat device could also be used in other seats which appear suitable to a person skilled in the art, such as in particular in motor vehicle seats, seats for lecture halls etc.

### BRIEF DESCRIPTION OF THE DRAWINGS

The accompanying figures, in which like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1 is a schematic side view of a seat device according to the invention in a first position; and

FIG. 2 is a side view of the aircraft seat according to FIG. 1 in a second position.

### DETAILED DESCRIPTION OF THE PREFERRED EMBODIMENTS

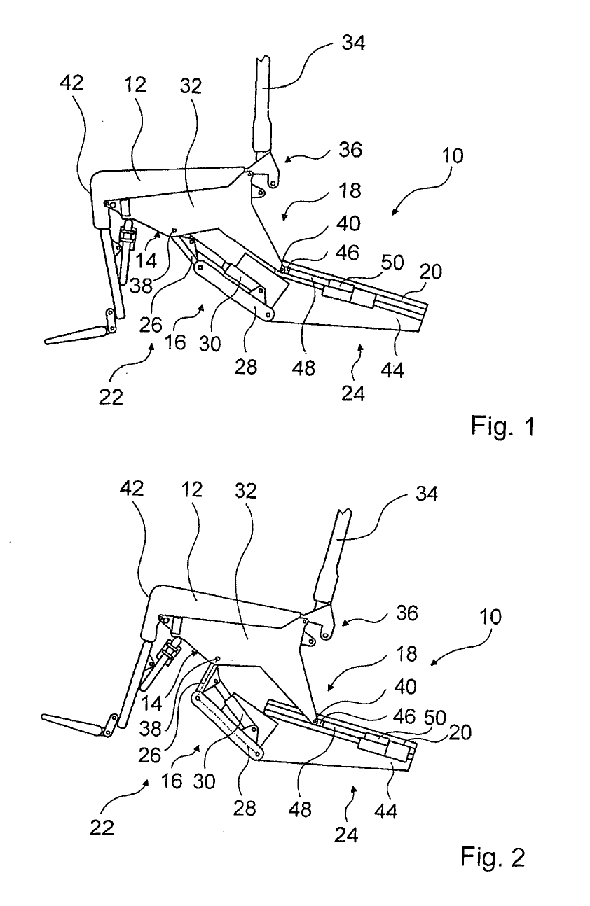

FIG. 1 shows a schematically illustrated aircraft seat in a side view with a seat device which comprises a seat base bearing apparatus 10 which is provided for movably supporting a seat base 12 of the aircraft seat. The seat base 12 is coupled via a carrier element 32 to the seat base bearing apparatus 10 which is provided for attachment to a cabin floor of an aircraft. The carrier element 32 is embodied as a separate component and is permanently connected to the seat base 12 of the aircraft seat. Alternatively, the carrier element 32 can also be embodied in one piece with the seat base 12.

In addition, the seat device comprises a backrest unit 34 and a backrest kinematic unit 36 which is only partially illustrated and by means of which the backrest unit 34 is coupled to the carrier element 32 and/or the seat base bearing apparatus 10.

The seat base bearing apparatus 10 comprises a first bearing unit 14 having at least a first bearing point 38 and a second bearing unit 18 having at least a second bearing point 40. The bearing units 14, 18 are coupled via the bearing points 38, 40 to the carrier element 32 and therefore to the seat base 12. In the present exemplary embodiment, two bearing points 38, 40 are provided. However, it is also possible to provide further bearing points on the seat base bearing device 10 which are spaced apart from one another, in particular in the transverse direction of the base 12 of the seat. Here, “transverse direction of the base of the seat” is to be understood in particular as meaning a direction which has at least one component parallel to a seat base front edge 42.

According to the invention, the first bearing unit 14 comprises a lever transmission 16, in which case the first bearing point 38 of the seat base bearing device 10 is connected to the lever transmission 16 which is in turn connected via a foot element 44 to the cabin floor of the aircraft. In the present exemplary embodiment, the lever transmission 16 has two levers 26, 28 which are connected to one another in an articulated fashion. However, further embodiments of lever transmissions which appear appropriate to a person skilled in the art, for example a lever transmission with a lever whose length is adjustable, are also possible. The two levers 26, 28 preferably have different lengths, while levers with identical lengths would also be possible. The shorter lever 26 is connected to the first bearing point 38, and the longer lever 28 is connected to the cabin floor of the aircraft via the foot element 44.

According to the invention, the second bearing unit 18 comprises a connecting link 20. The second bearing point 40 of the seat base bearing apparatus 10 has, for the purpose of guidance in the connecting link 20, a guiding element 46, preferably in the form of a guiding block, with the connecting link 20 being connected to the cabin floor of the aircraft via the foot element 44. In the present exemplary embodiment, the connecting link 20 which is lowered toward the rear has a linear profile, but any other profile of the connecting link 20 which appears appropriate to a person skilled in the art is also possible, for example a curved profile or a combination of linear and curved profile. The connecting link 20 preferably has a U-shaped cross section. The connecting link 20 which is attached to the foot element 44 extends laterally next to the second bearing point 40 in such a way that an opening 48 in the U-shaped cross section of the connecting link 20 faces the second bearing point 40.

The first bearing unit 14 is advantageously arranged in a front region 22, i.e., in a region of the seat device facing the seat base front edge 42, and the second bearing unit 18 is advantageously arranged in a rear region 24, i.e., in a region of the seat device facing the backrest unit 34.

In addition, the seat device has an actuation device 30 which serves to drive the seat base bearing apparatus 10. The actuation device 30 is provided on the lever transmission 16. In the present exemplary embodiment, the actuation device 30 is operatively connected to the two levers 26, 28 by virtue of the fact that it is connected to the two levers 26, 28. However, the actuation device 30 can also be arranged on the seat base bearing apparatus 10 in other ways which appear appropriate to a person skilled in the art, for example the actuation device 30 can be arranged between the carrier element 32 and foot element 44. In addition, the actuation device 30 can serve to damp the actuation movement of the seat device.

FIG. 1 shows the aircraft seat with the backrest unit 34 in an essentially upright position, such as corresponds, for example, to the starting, landing and rolling position (TTL position). In this context, the base 12 of the seat is in its frontmost position, with the second bearing point 40 of the second bearing unit 18 being located at the front in the connecting link 20, and the short lever 26 of the lever transmission 16 being pivoted forward. FIG. 2 shows the aircraft seat with the backrest unit 34 in a downward inclined position, that is to say in what is referred to as the travel position. In this context, the base 12 of the seat is in a rear position, in which case the second bearing point 40 of the second bearing unit 18 is located further toward the rear in the connecting link 20, and the short lever 26 of the lever transmission 16 is pivoted toward the rear.

If a passenger moves the backrest unit 34 from the TTL position into the travel position, the base 12 of the seat is moved toward the rear by means of the second bearing unit 18 in the connecting link 20. At the same time, the short lever 26 of the lever transmission 16 is pivoted toward the rear, which causes the base 12 of the seat to be lifted in its front region. In addition, the connecting link 20 is lowered toward the rear and therefore forms a ramp, with the result that the base 12 of the seat is additionally moved upward in its front region as a result of the movement to the rear and the pivoting of the short lever 26 to the rear.

The base 12 of the seat therefore carries out a combined movement, specifically a translatory and a rotational movement. When a desired position is reached, the backrest unit 34 and the base 12 of the seat are secured in their positions by a securing unit 50.

1. A seat device, in particular vehicle seat device or aircraft seat device, having a seat base bearing apparatus which is provided for movably supporting a seat base, wherein the seat base bearing apparatus has at least a first bearing unit with at least one lever transmission, and at least a second bearing unit with at least one connecting link.

2. The seat device as claimed in claim 1, wherein the first bearing unit is arranged in a front region of the seat device, and the second bearing unit is arranged in a rear region of the seat device.

3. The seat device as claimed in claim 2, wherein the lever transmission has at least one lever.

4. The seat device as claimed in claim 3, wherein the lever is longitudinally adjustable.

5. The seat device as claimed in claim 2, wherein the seat device includes an actuation device, which serves to drive the seat base bearing apparatus.

6. The seat device as claimed in claim 1, wherein the lever transmission has at least one lever.

7. The seat device as claimed in claim 6, wherein the lever is longitudinally adjustable.

8. The seat device as claimed in claim 1, wherein the lever transmission has at least two levers, which are connected to one another in an articulated fashion.

9. The seat device as claimed in claim 8, wherein the levers are either of different lengths or of the same length.

10. The seat device as claimed in claim 1, wherein the connecting link has a linear or a curved profile.

11. The seat device as claimed in claim 1, wherein the connecting link has a U-shaped cross section.

12. The seat device as claimed in claim 1, wherein the seat device includes an actuation device, which serves to drive the seat base bearing apparatus.

13. The seat device as claimed in claim 12, wherein the actuation device is provided on the lever transmission.

14. The seat device as claimed in claim 13, wherein the actuation device is operatively connected to at least one lever.

15. The seat device as claimed in claim 14, wherein the actuation device additionally serves to damp the actuation movement of the seat device.

16. The seat device as claimed in claim 13, wherein the actuation device additionally serves to damp the actuation movement of the seat device.

17. The seat device as claimed in claim 12, wherein the actuation device additionally serves to damp the actuation movement of the seat device.

18. The seat device as claimed in claim 12, wherein the actuation device is operatively connected to at least one lever.

19. The seat device as claimed in claim 1, wherein the seat device is a vehicle or aircraft seat.
